(19) United States
(12) Patent Application Publication
(10) Pub. No.: US 2009/0129478 A1
(43) Pub. Date: May 21, 2009

(54) DEBLOCKING FILTER

(75) Inventor: Yan Meroth, Saint Marcellin (FR)

Correspondence Address: SEED INTELLECTUAL PROPERTY LAW GROUP PLLC, 701 FIFTH AVENUE, SUITE 5400, SEATTLE, WA, 98104-7092, US

(73) Assignee: STMICROELECTRONICS SA, Montrouge (FR)

(21) Appl. No.: 12/271,457

(22) Filed: Nov. 14, 2008

(30) Foreign Application Priority Data
Nov. 16, 2007 (EP) 07301554.7

(51) Int. Cl. H04N 7/26

(52) U.S. Cl. 375/240.24; 375/E07.189

(57) ABSTRACT

A multi-standard deblocking filter for deblocking video images including a deblocking unit configured to deblock edges of a current macroblock of an image based on samples taken from a first sample window comprising said current macroblock and a second sample window adjacent to said first sample window; three memory banks coupled to said deblocking unit, a first memory bank arranged to store samples of said first sample window, a second memory bank arranged to store samples of said second sample window, and a third memory bank arranged to store samples of a third sample window adjacent to the second sample window comprising a macroblock deblocked in a previous deblocking operation; and control circuitry to control, during a same macroblock deblocking operation, loading and deblocking of said current macroblock and outputting of samples of said third sample window from the third memory bank.

### BACKGROUND

1. Technical Field

The present disclosure relates to a deblocking filter, and in particular to a multi-standard deblocking filter.

2. Description of the Related Art

Deblocking filters are used in video compression/decompression systems to reduce blocking artifacts in image frames, and thus to improve image quality. Such blocking artifacts result from the block-based processing of pixels during video compression, which can cause step changes in the image data at the boundaries between pixel blocks, referred to herein as edges. The deblocking filter performs a filtering operation on an area of pixels on each side of the edges to smooth the step changes and improve image quality.

There exist numerous compression standards used for video data compression, and new standards continue to be developed. Examples of currently used standards include MPEG-4 SP/ASP (simple profile/advanced simple profile), MPEG-4 AVC (advanced video coding), H.263, H.264, VC1 and DivX6. Standards may define specific deblocking filter algorithms to be used, each algorithm being based on certain edges and certain input samples.

It is becoming a requirement in many electronic devices such as set-top boxes, mobile telephones, PDAs (personal digital assistants), hand-held games consoles etc., to provide video decoders that can support multiple video compression/decompression standards. Due to the varying deblocking algorithms used by the different standards, such multi-standard devices generally use dedicated deblocking filters for each format. However, this solution is demanding on chip area. Alternatively, software solutions have been proposed, but these tend to be very demanding on processing power, which is generally not available in small electronics devices, meaning that real-time deblocking is not possible and/or is very power consuming. There is thus a need for a multi-standard deblocking filter circuit that is compact and that can operate in real-time.

### BRIEF SUMMARY

According to one embodiment, there is provided a multi-standard deblocking filter for deblocking video images comprising: a deblocking unit arranged to perform deblocking on edges of a current macroblock of an image based on samples taken from a first sample window comprising said current macroblock and a second sample window adjacent to said first sample window; three memory banks coupled to said deblocking unit, a first one of said memory banks arranged to store samples of said first sample window, a second one of said memory banks arranged to store samples of said second sample window, and a third one of said memory banks arranged to store samples of a third sample window adjacent to the second sample window comprising a macroblock deblocked in a previous deblocking operation; and control circuitry arranged to control, during a same macroblock deblocking operation, loading and deblocking of said current macroblock and outputting of samples of said third sample window from said third one of said memory banks.

According to one embodiment, the multi-standard deblocking filter further comprises renaming circuitry for renaming said memory banks after each deblocking operation such that said first sample window becomes said second sample window and said second sample window becomes said third sample window.

According to another embodiment, the multi-standard deblocking filter further comprises first and second buffers arranged to store blocks of samples taken from said first and second sample windows for processing by said deblocking unit.

According to another embodiment, the multi-standard deblocking filter further comprises an interconnect coupled to said first and second buffers, to said three memory banks, to a memory controller and to said deblocking unit, said interconnect arranged to allow communication between said first buffer and said deblocking unit at the same time as communication between said second buffer and one of said three memory banks.

According to another embodiment, there is provided electronic device comprising a processor, a memory and the above multi-standard deblocking filter.

According to another embodiment, there is provided a mobile telephone comprising a processor, a memory, a display and the above multi-standard deblocking filter.

According to another embodiment, there is provided a method of deblocking multi-standard video images, comprising: loading samples of a first sample window of a video image into a first memory bank, said first sample window comprising a current macroblock to be deblocked; deblocking edges of said current macroblock based on samples taken from said first sample window and taken from a second sample window adjacent to said first sample window stored in a second memory bank and storing the result in said first and/or second memory banks; and during said loading and deblocking steps, outputting samples of a third sample window stored in a third memory bank.

According to an embodiment, the method further comprises renaming said first and second memory banks after said deblocking step such that the first sample window becomes the second sample window and the second sample window becomes the third sample window, and loading a next macroblock to be deblocked into said third memory bank.

According to another embodiment, said outputting step comprising outputting said samples of the third sample window to a deringing filter.

According to another embodiment, loading, deblocking and outputting steps relate to luma samples of a video image, and further comprising performing said steps for chroma samples of said video image.

In an embodiment, a multi-standard deblocking filter to deblock video images comprises: a deblocking unit configured to deblock edges of a current macroblock of an image based on samples taken from a first sample window comprising the current macroblock and a second sample window adjacent to the first sample window; three memory banks coupled to the deblocking unit, a first one of the memory banks arranged to store samples of the first sample window, a second one of the memory banks arranged to store samples of the second sample window, and a third one of the memory banks arranged store samples of a third sample window adjacent to the second sample window comprising a macroblock deblocked in a previous deblocking operation; and control circuitry arranged to control, during a macroblock deblocking operation, loading and deblocking of the current macroblock and outputting of samples of the third sample window from the third one of the memory banks. In one embodiment, the multi-standard deblocking filter further comprises circuitry configured to redesignate the memory banks after each deblocking operation such that the first sample window becomes the second sample window and the second sample window becomes the third sample window. In one embodiment, the multi-standard deblocking filter further comprising first and second buffers arranged to store blocks of samples taken from the first and second sample windows for processing by the deblocking unit. In one embodiment, the multi-standard deblocking filter further comprises an interconnect coupled to the first and second buffers, to the three memory banks, to a memory controller and to the deblocking unit, the interconnect configured to simultaneously allow communication between the first buffer and the deblocking unit and between the second buffer and one of the three memory banks.

In one embodiment, an electronic device comprises: a processor; a memory; a deblocking unit configured to deblock edges of a current macroblock of an image based on samples taken from a first sample window comprising the current macroblock and a second sample window adjacent to the first sample window; three memory banks coupled to the deblocking unit, a first one of the memory banks arranged to store samples of the first sample window, a second one of the memory banks arranged to store samples of the second sample window, and a third one of the memory banks arranged store samples of a third sample window adjacent to the second sample window comprising a macroblock deblocked in a previous deblocking operation; and control circuitry arranged to control, during a macroblock deblocking operation, loading and deblocking of the current macroblock and outputting of samples of the third sample window from the third one of the memory banks. In one embodiment, the electronic device further comprises a display. In one embodiment, the electronic device further comprises a transceiver configured to send and receive mobile telephone communication signals.

In one embodiment, a method of deblocking multi-standard video images comprises: loading samples of a first sample window of a video image into a first memory bank, the first sample window comprising a current macroblock to be deblocked; deblocking edges of the current macroblock based on samples taken from the first sample window and samples taken from a second sample window adjacent to the first sample window and stored in a second memory bank and storing a result in the first and/or second memory banks; and during the loading and deblocking steps, outputting samples of a third sample window stored in a third memory bank. In one embodiment, the method further comprises renaming the first and second memory banks after the deblocking step such that the first sample window becomes the second sample window and the second sample window becomes the third sample window, and loading a next macroblock to be deblocked into the third memory bank. In one embodiment, the outputting step comprises outputting the samples of the third sample window to a deringing filter. In one embodiment, the loading, deblocking and outputting steps relate to luma samples of a video image, and further comprising performing the loading, deblocking and outputting steps for chroma samples of the video image. In one embodiment, the first sample window further comprises a plurality of samples of at least one macroblock adjacent to the current macroblock.

In one embodiment, a video image deblocking filter comprises: a window buffer configured to: store a sample window including samples of a current macroblock and a sample window including samples of a macroblock adjacent to the current macroblock; and output samples from a sample window including samples of a previously deblocked macroblock; and a deblocking module coupled to the window buffer and configured to deblock edges of the current macroblock based on stored samples from the window including samples of the current macroblock and stored samples from the window including samples of the macroblock adjacent to the current macroblock. In one embodiment, the window buffer comprises three memory banks and a controller configured to control storage of the sample windows in the three memory banks and to control access by the deblocking module to the memory banks. In one embodiment, the window buffer controller is configured to redesignate the memory banks in response to completion of deblocking of the current macroblock.

In one embodiment, a computer readable memory medium stores instructions to cause a video signal processing system to perform a method, the method comprising: loading samples of a first sample window of a video image into a first memory bank, the first sample window comprising a current macroblock to be deblocked; deblocking edges of the current macroblock based on samples taken from the first sample window and samples taken from a second sample window adjacent to the first sample window and stored in a second memory bank and storing a result in the first and/or second memory banks; and during the loading and deblocking steps, outputting samples of a third sample window stored in a third memory bank. In one embodiment, the method further comprises redesignating the first and second memory banks after the deblocking step such that the first sample window becomes the second sample window and the second sample window becomes the third sample window, and loading a next macroblock to be deblocked into the third memory bank. In one embodiment, the outputting step comprises outputting the samples of the third sample window to a deringing filter. In one embodiment, the loading, deblocking and outputting steps relate to luma samples of a video image, and the method further comprises performing the loading, deblocking and outputting steps for chroma samples of the video image.

In one embodiment, a system comprises: means for storing at least three windows of samples associated with a video image; means for deblocking edges of macroblocks in the video image based on samples of a macroblock to be deblocked and samples of a macroblock adjacent to the macroblock to be deblocked; and means for designating for a deblocking cycle windows of samples in the means for storing as associated with the macroblock to be deblocked, the macroblock adjacent to the macroblock to be deblocked, and a previously deblocked macroblock, wherein the means for deblocking is configured to retrieve the samples of the macroblock to be deblocked from the window of samples associated with the macroblock to be deblocked and to retrieve the samples of the macroblock adjacent to the macroblock to be deblocked from the window of samples associated with the macroblock adjacent to the macroblock to be deblocked. In one embodiment, the means for storing comprises three memory banks each configured to store a window of samples associated with the video image and the means for designating is configured to selectively designate the memory banks with respective macroblocks associated with the video image. In one embodiment, the system further comprises means for outputting samples associated with the previously deblocked macroblock during the deblocking cycle. In one embodiment, the means for designating is configured to redesignate the windows of samples in the means for storing in response to a completion of a deblocking cycle.

### BRIEF DESCRIPTION OF THE SEVERAL VIEWS OF THE DRAWINGS

The foregoing and other purposes, features, aspects and advantages will become apparent from the following detailed description of embodiments, given by way of illustration and not limitation with reference to the accompanying drawings, in which:

FIG. 1 illustrates a functional block diagram of a video decoder according to an embodiment;

FIG. 2A and 2B illustrate luma and chroma pixel blocks respectively on which one type of deblocking is performed according to an embodiment;

FIGS. 3A and 3B illustrate luma and chroma pixel blocks respectively on which another type of deblocking is performed according to an embodiment;

FIGS. 3C and 3D illustrate luma and chroma pixel blocks respectively on which another type of deblocking is performed according to an embodiment;

FIGS. 3E and 3F illustrate luma and chroma pixel blocks respectively on which another type of deblocking is performed according to an embodiment;

FIG. 4 illustrates a functional block diagram of a video post-processor according to an embodiment;

FIG. 5 illustrates a window buffer of the processor of FIG. 4 in more detail according to an embodiment;

FIGS. 6A and 6B illustrate luma and chroma pixel blocks respectively and show contents of data banks of FIG. 4 according to an embodiment;

FIG. 7 is a flowchart illustrating steps of a deblocking loop according to an embodiment;

FIG. 8 illustrates the processing order during deblocking according to an embodiment;

FIG. 9 is a flowchart illustrating steps in a method of performing horizontal or vertical deblocking according to an embodiment; and

FIG. 10 illustrates an electronics device according to an embodiment.

### DETAILED DESCRIPTION

FIG. 1 illustrates a video decoding system 100 comprising a decode and decompression block 101 and a deblocking/deringing block 102, coupled to a display unit 104. Decode and decompression block 101 comprises circuitry for decoding and decompressing a bitstream received on an input line 110, which may be encoded and compressed in any one of a number of different standards. Block 101 for example comprises an entropy decoder, an inverse discrete cosine transform block, motion compensation circuitry etc. The output of decode and decompression block 101 is provided to deblocking/deringing block 102, which comprises a deblocking filter 106 and optionally a deringing filter 108. The deblocking filter 106 is a multi-standard filter that is able to perform deblocking according to a number of different standards supported by the decode and decompression block 101. In one embodiment the different standards comprise MPEG-4, H.263, H.264 (also known as MPEG-4 advanced video coding), H.264 RCDO (reduced complexity decoder operations), VC1, DivX5 (which uses the same deblocking as MPEG-4) and DivX6. Deringing filter 108 receives the output of the deblocking filter, and performs deringing that reduces ghost or halo effects in the image that can result from the video decoding process. The output of the deringing block 108 is provided to the display unit 104 for display.

In the example of FIG. 1, block 102 can operate as both a video post-processing (VPP) unit of a video decoder that performs deblocking on the video data independently of and after the decoding and decompressing performed by decode and decompression block 101, and also as an in-loop deblocking filter. A bitstream 110 is received, for example from a wireless interface, and decoded, decompressed and reordered by block 101. Decoded and decompressed packets are provided on line 111 to the deblocking filter 106. If the deblocking filter is operating as a VPP unit, the packets are deblocked and output on lines 112 to the deringing filter 108, where a deringing algorithm is applied, and then they are output to a display unit 104. On the other hand, for some video standards, block 102 operates as an in-loop deblocking filter, in which case packets of deblocked data are returned to the decode and decompression block 101 on line 113, prior to being reordered, and output to the deringing filter 108 and display unit 104.

Alternatively, deblocking filter 106 may be part of a video encoder that implements deblocking prior to compression of the video stream. In this embodiment, bitstream 110 is for example provided from an encode and compression engine (not shown). In this embodiment, no deringing is performed, and the output of the deblocking filter 106 is provided back to the encode and compression engine, as shown by dashed arrow 114, for use in the encoding and compression process to generate a compressed deblocked video bitstream.

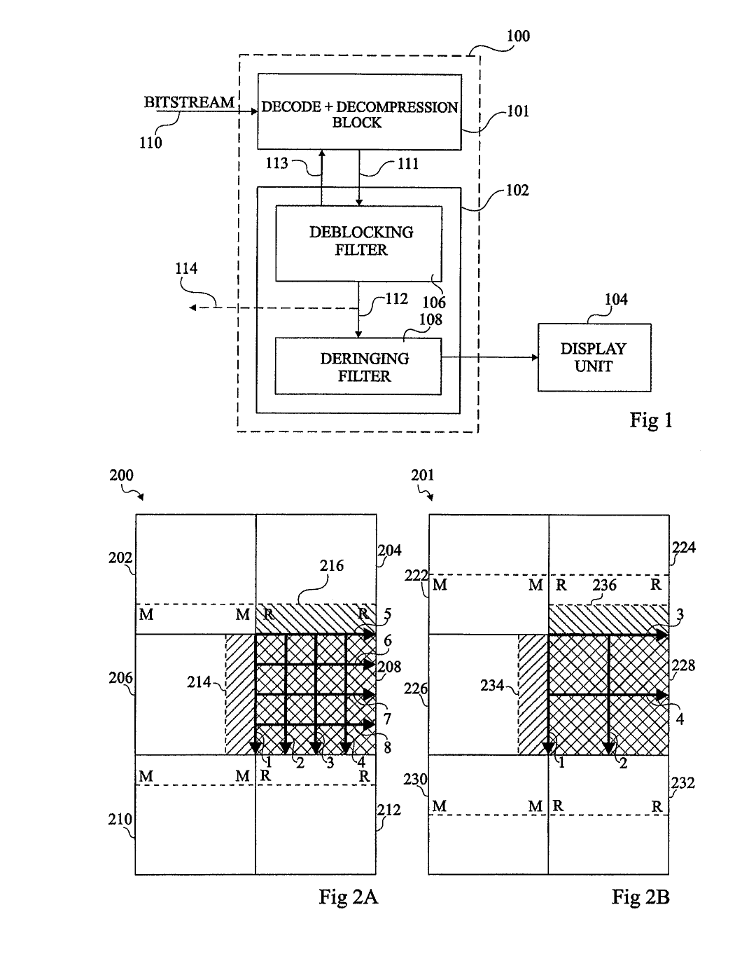

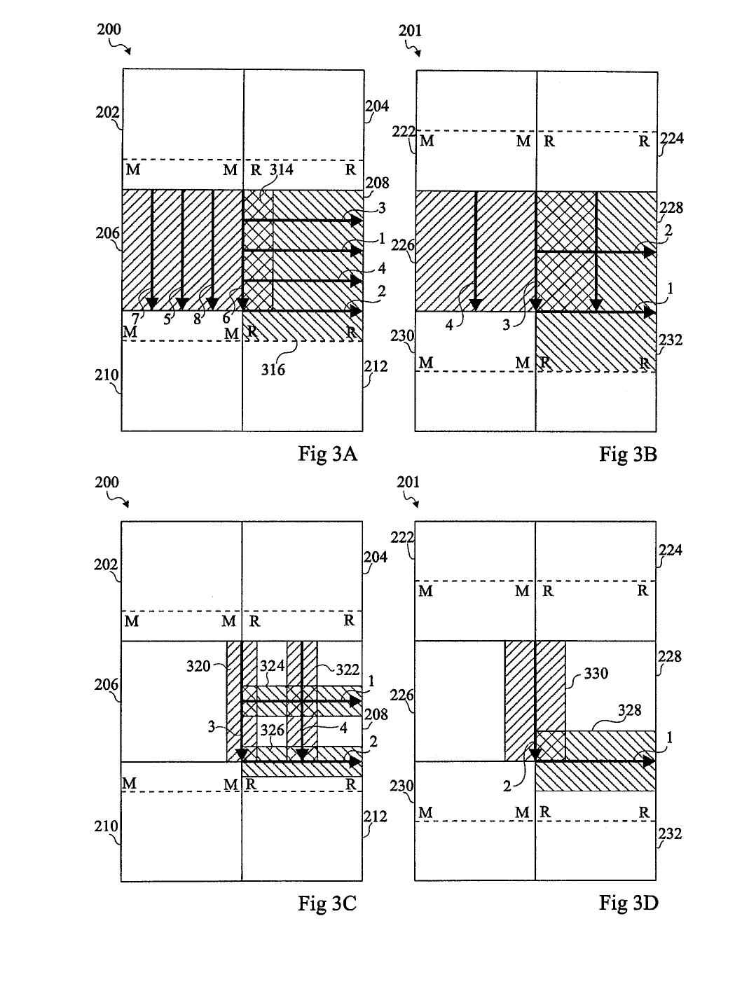

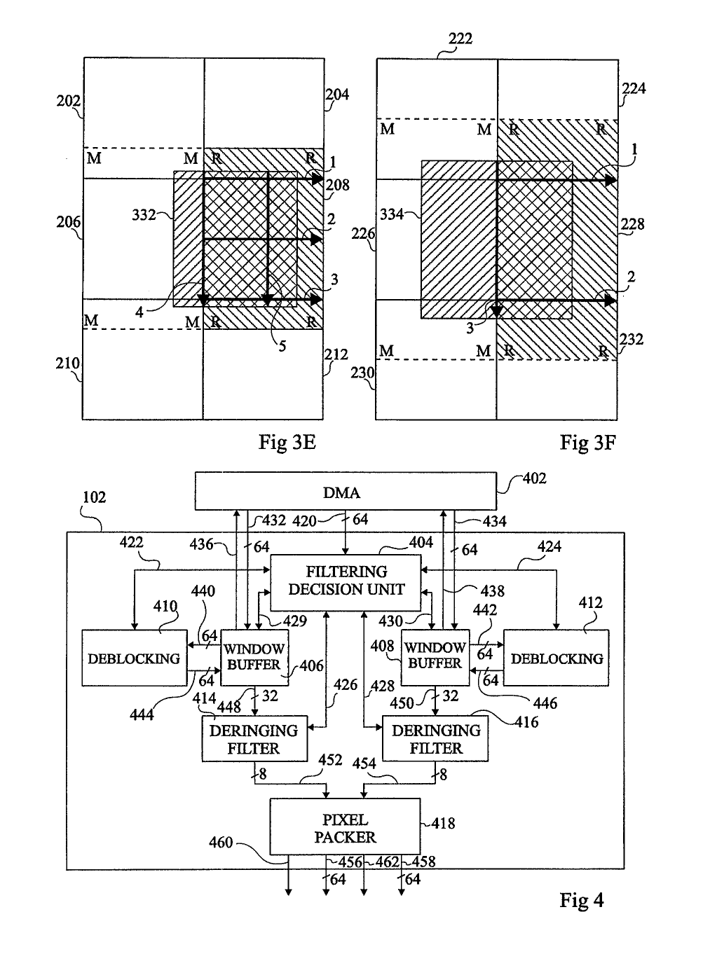

As explained above, deblocking is performed on edges of blocks of samples based on the values of surrounding samples. The location of the edges and the locations of the surrounding samples to be used in the deblocking process depend on the compression standard of the pictures. Deblocking of pictures compressed by H.264, VC1, H.263 and MPEG-4 will now be described with reference to FIGS. 2A, 2B and 3A to 3F.

FIGS. 2A and 2B illustrate groups of luma and chroma macroblocks respectively.

With reference to FIG. 2A, a group of six luma macroblocks 200 is illustrated comprising two adjacent macroblocks 202, 204 in a first row, two adjacent macroblocks 206, 208, directly below blocks 202 and 204 respectively, and two adjacent macroblocks 210, 212 directly below blocks 206 and 208 respectively. In this example each macroblock represents a set of 16 by 16 luma data samples, each sample comprising 8 bits. In other words, each macroblock represents 16 words of 128 bits. Deblocking is performed by processing each macroblock in turn, using data from that macroblock as well as from a number of adjacent macroblocks.

FIG. 2A shows macroblocks from a picture compressed according to the H.264 standard, and illustrates the processing performed to deblock luma samples of macroblock 208. Dark arrows 1 to 8 show the edges that are processed, all of which are within or border macroblock 208, the filter being applied to the numbered edges in order, in the direction of the arrows. Vertical edges 1 to 4 are processed based on samples in region 214 of macroblock 206, adjacent and to the left of macroblock 208, and on the pixel samples of macroblock 208, these regions being diagonally striped from bottom left to top right in FIG. 2A. Region 214 represents a rectangle of samples 4 wide and 16 high, bordering edge 1. Horizontal edges 5 to 8 are processed based on the samples in a region 216 of the macroblock 204, adjacent to and above macroblock 208, and on the samples of macroblock 208, these regions being diagonally striped from top left to bottom right in FIG. 2A. Region 216 represents a rectangle of samples 16 wide, and 4 high, bordering edge 5.

With reference to FIG. 2B, a group of six chroma macroblocks 201 is illustrated comprising two adjacent macroblocks 222, 224 in a first row, two adjacent macroblocks 226, 228 directly below blocks 222 and 224 respectively, and two adjacent macroblocks 230, 232 directly below blocks 226 and 228 respectively. In this example each macroblock represents a set of 8 by 8 red chroma samples, each sample comprising 8 bits. In other words, each macroblock comprises 8 words of 64 bits. Deblocking is performed by processing each chroma macroblock in turn, using data from that macroblock as well as from a number of adjacent macroblocks. The deblocking of macroblocks for blue chroma samples is identical to that of red chroma samples and therefore the blue chroma macroblocks have not been illustrated.

FIG. 2B shows part of a picture compressed according to the H.264 standard, and illustrates the processing performed to deblock chroma samples of macroblock 228. Dark arrows 1 to 4 show the edges that are processed, the filter being applied to the numbered edges in order, in the direction of the arrows. Vertical edges 1 and 2 are processed based on samples in region 234 in macroblock 226, adjacent and to the left of macroblock 228, and on the samples of macroblock 228, these regions being diagonally striped from bottom left to top right in FIG. 2B. Region 234 represents a rectangle of chroma pixel samples 2 wide and 8 high, bordering edge 1. Horizontal edges 3 and 4 are processed based on the pixels samples in a region 236 of the macroblock 224, adjacent to and above macroblock 228, and on the pixel samples of macroblock 228, these regions being diagonally striped from top left to bottom right in FIG. 2B. Region 236 represents a rectangle of chroma samples 8 wide, and 2 high, bordering edge 3.

As will be described in more detail below, deblocking of macroblock 208 is performed by loading two sets of samples into respective memory banks for luma samples, and likewise for chroma samples. These sets will be referred to herein as sample windows. For luma samples, a middle sample window comprises the macroblock to the left of the macroblock being processed, i.e. macroblock 206 in FIG. 2A, as well as a group of samples above and below this macroblock having the width of a macroblock and a height of four pixels. The middle macroblock is shown in FIG. 2A with a letter “M” in each corner and delimited top and bottom by a dashed line. A right sample window has the same dimensions as the middle sample window, but is centered on the macroblock being processed, i.e. macroblock 208 in FIG. 2A. The right sample window is shown in FIG. 2A with a letter “R” in each corner, and delimited top and bottom by a dashed line.

For chroma samples, a middle sample window comprises the macroblock to the left of the macroblock being processed, i.e. macroblock 226 in FIG. 2B, as well as a group of samples above and below this macroblock having the width of a macroblock and a height of four chroma pixel samples. The middle macroblock is shown in FIG. 2B with a letter “M” in each corner and delimited top and bottom by a dashed line. A right sample window has the same dimensions as the middle sample window, but is centered on the macroblock being processed, i.e. macroblock 228 in FIG. 2A. The right sample window is shown in FIG. 2B with a letter “R” in each corner, and delimited top and bottom by a dashed line.

FIGS. 3A and 3B illustrates the same six luma and chroma macroblocks of FIGS. 2A and 2B, but show deblocking according to the VC1 standard.

When the luma samples of macroblock 208 are being processed, horizontal edges shown by arrows 1 to 4, which are within or border macroblock 208, are filtered in order. Then, vertical edges 5 to 7, which are all within or border macroblock 206 to the left of macroblock 208, are filtered in order. As illustrated in FIG. 3A by the regions diagonally striped from bottom left to top right, for vertical edges, the pixel samples used are the whole of macroblock 206 and a strip of macroblock 208 bordering macroblock 206, which is 4 pixel samples wide and 16 pixels high. As illustrated by regions diagonally striped from top left to bottom right, for horizontal edges, the pixel samples used are the whole of macroblock 208 and a strip of macroblock 212 bordering macroblock 208, which is 16 pixel samples wide and 4 pixel samples high.

When the chroma samples of macroblock 228 are being processed, horizontal edges shown by arrows 1 and 2, which are within or border macroblock 228, are filtered in order. Then, vertical edges 3 and 4, which are within or border macroblock 226 to the left of macroblock 228, are filtered in order. As illustrated in FIG. 3B by the regions diagonally striped from bottom left to top right, for vertical edges, the pixel samples used are the whole of macroblock 226 and a strip of macroblock 228 bordering macroblock 226, which is 4 samples wide and 8 samples high. As illustrated by regions diagonally striped from top left to bottom right, for horizontal edges, the pixel samples used are the whole of macroblock 228 and a strip of macroblock 232 bordering macroblock 228, which is 8 samples wide and 4 samples high.

FIGS. 3C, 3D, 3E and 3F illustrates the same six luma and chroma macroblocks of FIGS. 2A and 2B, but show deblocking according to the H.263 standard (FIGS. 3C and 3D) and the MPEG-4 AVC standard (FIGS. 3E and 3F). In these figures, the same representations are used for the edges and the regions of pixel samples used to filter the edges, and therefore these figures will not be described in detail. However, it should be noted that in FIG. 3C, strips 320 and 322 are 4 samples wide and 16 samples high, and strips 324 and 326 are 16 samples wide and 4 samples high. In FIG. 3D, strip 328 is 4 samples high and 8 samples wide, and strip 330 is 4 samples wide and 8 samples high. In FIG. 3E, region 332 is 2 samples higher than a macroblock, and the same width as a macroblock, and overlaps macroblock 206 by 4 samples. In FIG. 3F, region 334 is one macroblock wide, and 2 samples higher the height of a macroblock, and overlaps macroblock 226 by 4 samples.

The middle and right sample windows are the same in the deblocking standards of FIGS. 3A to 3F described above as for H.264 deblocking of FIGS. 2A and 2B. This is possible as the size of these sample windows is advantageously chosen to provide the pixel samples used in any of the standards.

FIG. 4 illustrates the deblocking/deringing block 102 of FIG. 1 in more detail, according to one example. As illustrated, block 102 is coupled to a DMA (direct memory access) unit 402, which provides decoded and decompressed data packets and other parameters from a memory (not shown).

Block 102 comprises a filtering decision unit (FDU) 404, coupled to a window buffer 406 for luma video data, and a window buffer 408 for chroma video data. Window buffer 406 is coupled to a deblocking filter 410 for luma video data, while window buffer 408 is coupled to a deblocking filter 412 for chroma video data. Window buffers 406, 408 are further coupled to respective deringing filters 414 and 416, which are in turn coupled to a pixel packer 418.

The FDU 404 receives parameter data from the DMA on lines 420, these parameters being used by the deblocking filters and the deringing filters for processing each data packet. FDU 404 is coupled to the deblocking filters 410, 412 by lines 422, 424 respectively, and to deringing filters 414, 416 by lines 426, 428 respectively, for providing the deblocking and deringing parameters. The deblocking/deringing parameters are specific to the compression standard of the received data packets and are for example generated by a host processor, or by a dedicated hardware block. FDU 404 is also coupled to window buffers 406, 408 by lines 429, 430, for monitoring the status of the window buffers and providing instructions which determine characteristics of the filter processes, such as which edges will or will not be filtered.

The window buffers 406, 408 receive luma data and chroma data packets on respective input lines 432, 434 from the DMA, each data packet comprising 64 bits. Data packets are provided to the window buffers 406, 408 in response to requests made to the DMA on lines 436, 438 respectively, the requests comprising request parameters including for example the location of the pixel samples required, generally defined as the top left corner of the required block of pixel samples, the width and height of the block of pixel samples, the format of the pixel chroma samples, for example blue or red chroma packet, or blue and red samples interleaved, and the scan order, which specifies if packets of a requested area are received in a row-first order or a column first order. Window buffers 406, 408 are accessed by deblocking filters 410, 412 respectively via lines 440, 442, and receive deblocked video data from the deblocking filters via lines 444 and 446 respectively. The window buffers 406, 408 output deblocked video data packets to deringing filters 414 and 416 on lines 448, 450 respectively.

Deringing filters 414 and 416 perform deringing on the video data, and output the data, in this example in 8-bit bytes, on lines 452, 454 to the pixel packer 418.

Pixel packer 418 generates video data packets for output having desired format, for example YCbCr 4:2:0, which is homogeneous with the video codec's input format, or 4:2:2, which is typical of SVideo display. The luma and chroma data packets are output in 64 bits on lines 456 and 458 respectively. Parameters relating to the luma and chroma data respectively are also provided on lines 460, 462, indicating for example the location, width, height, format and scan order of the block of pixel samples being output.

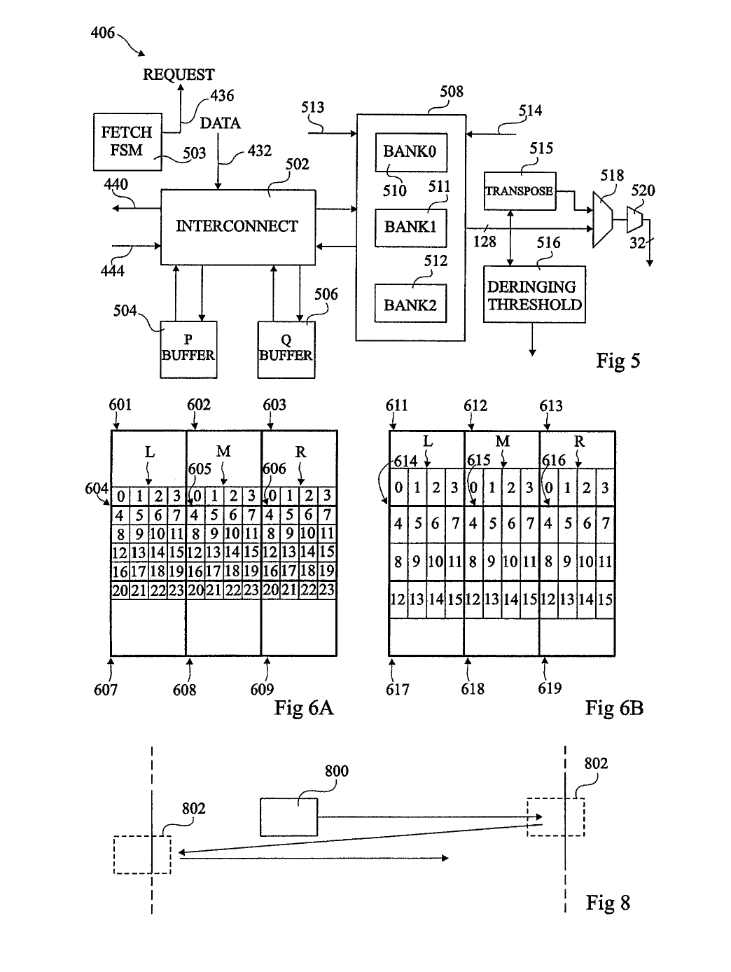

FIG. 5 illustrates window buffer 406 relating to luma video data in more detail according to one example. Input/output lines corresponding to those shown in FIG. 4 have been labeled with like reference numerals. Window buffer 408 relating to chroma video data may have an almost identical structure as buffer 406, the only difference being the size of the memory banks/buffers as explained in more detail below.

Window buffer 406 comprises an interconnect 502, which receives luma video data on lines 432 from the DMA 402 (not shown in FIG. 5) in response to requests made by a fetch FSM (finite state machine) 503 on lines 436. Interconnect 502 is further connected to the deblocking filter 410 via lines 440, 444, to a P buffer 504, to a Q buffer 506, and to a memory 508. Interconnect 502 facilitates retrieving data from either P buffer 504 or Q buffer 506 at the same time as the other P or Q buffer is being read from or written to by memory 508.

Memory 508 comprises three memory banks, 510, 511 and 512. It also receives control signals on lines 513 for controlling loading data into and accessing data from interconnect 502, and receives control signals on lines 514 for controlling outputting the data from one of the banks to the deringing filter. The control signals are for example generated by a host processor, embedded microprocessor, micro-programmed finite state machine, hard-wired state machine or the like.

An output of the memory 508 is coupled to a transpose block 515, a deringing threshold block 516, and to one input of a two-input multiplexer 518, which also receives the output of transpose block 515, such that either the original or transposed output can be selected. The output of multiplexer 518 is connected to a multiplexer 520, which is controlled to output the video data in packets of 32 bits.

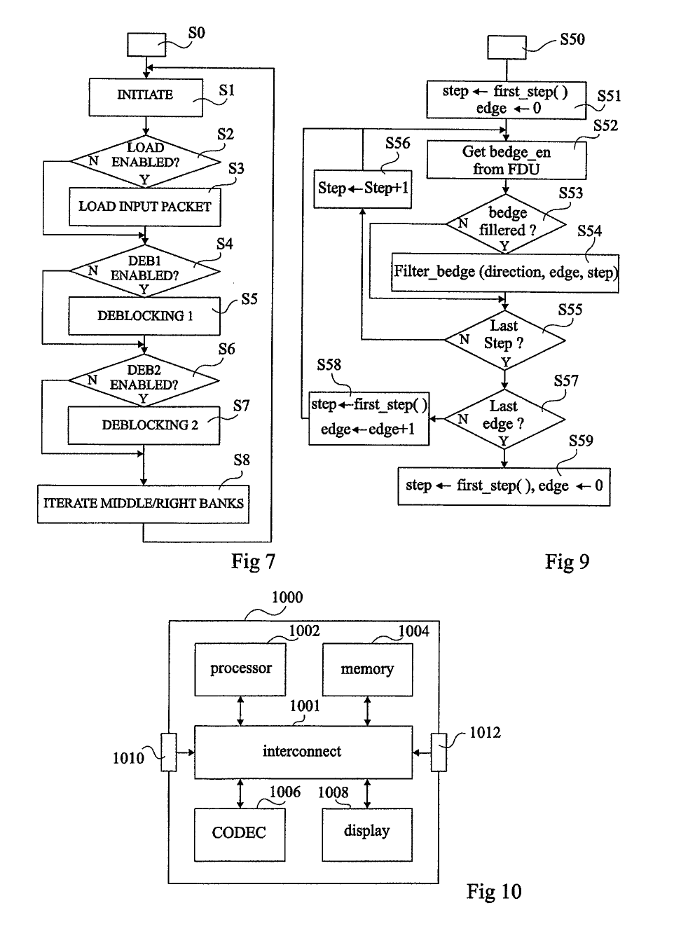

Operation of the window buffer 406 of FIG. 5 during deblocking will now be described with reference to FIGS. 6A, which illustrates a 3 by 3 set of luma macroblocks 601 to 609 at the top left-hand corner of an image and to FIG. 7, which is a flow diagram illustrating steps in a method applying a deblocking filter to a macroblock. This is a generic method that applies to all compression standards supported by the embodiments described herein.

Two of the three banks 510, 511 and 512 of memory 508 are used to store a middle and right sample windows, which are used during a current deblocking filtering process. The third bank stores a left sample window, which was previously the middle sample window, and which is ready to be output to the deringing filter. The left sample window is output during the deblocking of the middle and right sample windows. The left, middle and right sample windows relating to macroblocks 604, 605 and 606 respectively are illustrated in FIG. 6A, each comprising 24 sub-blocks of 4 by 4 samples. These sub-blocks are labeled 0 to 23 in FIG. 6A, and sub-blocks 0 to 3 are part of the macroblock above, while blocks 20 to 23 are part of the macroblock below. For example, the right sample window illustrated comprises sub-blocks 0 to 3, which are the bottom row of sub-blocks of macroblock 603, sub-blocks 4 to 19 are the sub-blocks of macroblock 606, and sub-blocks 20 to 23 are the top row of sub-blocks of macroblock 609. The sub-blocks illustrated in FIG. 6A represent the contents of the banks 510, 511 and 512 when the left sample window comprising macroblock 604 has been processed and is ready for output, and the right sample window comprising macroblock 606 has just been loaded for processing, using samples from the middle sample window comprising macroblock 605.

Initially, at the starting step S0 in FIG. 7, the three banks 510 to 512 are empty. Transition from S0 to S1 is for example triggered by a host processor. This transition enables parallel execution by fetch FSM 503, which generates requests for sample windows to the DMA according to the scan order described above in relation to FIG. 8. A first sample window of an image frame to be loaded comprises macroblock 601 of FIG. 6A.

At step S1, an initiate step comprises a check is made whether the bank associated with the right sample window is empty, and an instruction Instr is received from the FDU for performing further steps S2, S4 and S6.

At step S2, Instr is decoded in order to determine whether or not a new sample window is to be loaded. This process allows the loading of sample windows to be stopped after the last sample window of the image frame has been loaded, but processing continues such that the last sample window is output to the deringing filter. If load is disabled, no sample window load occurs, and the next step is S4. Generally, a load is enabled, and the next step is S3, in which the sample window is loaded into memory 508 as a right sample window. In this example, the first sample window comprises macroblock 601 and is loaded via interconnect 502 into bank 510, preferably via P and Q buffers 504, 506, which allow translation of the sample arrangement of incoming data packets into the desired memory organization. This first sample window will not comprise any samples from the area above macroblock 601 as there are none, and instead the DMA or window buffer will fill sub-blocks 0 to 3 of the right sample window in the memory bank with zeros for example, or replications of sub-blocks 4 to 7.

Next, in step S4, Instr is decoded in order to determine whether a first type of deblocking DEB1 is to be performed. Generally, the first type of deblocking is deblocking relating to horizontal edges, but in some cases it could be deblocking relating to vertical edges. If the DEB1 is enabled, the next step is S5, otherwise it is S6. In the present example, DEB1 is horizontal deblocking, which is performed in step S5 on macroblock 601 based on the right sample window stored in bank 510. Horizontal deblocking does not require any samples from the middle sample window, and therefore it can be performed before a middle sample window has been loaded. This step will be described in more detail below, and involves transferring sub-blocks to buffers 504 and 506 of FIG. 5.

In step S6, Instr is decoded in order to determine whether a second type of deblocking DEB2 is to be performed. If DEB1 is horizontal deblocking, then DEB2 is vertical deblocking, and vice versa. If DEB2 is to be performed, the next step is S7 in which DEB2 is performed. Otherwise the next step is S8. In the present example, vertical deblocking is performed on the first sample window only in some cases, and for example is performed if the processing to be applied is that of FIG. 3C or 3E, but not if the processing to be applied is that of FIG. 3A, 3B, 3D or 3F.

In step S8, the right sample window becomes the middle sample window, the middle sample window becomes the left sample window, and the left sample window becomes the right sample window. Rather than transferring data from one of the banks to another, processing power and time are economized by renaming or redesignating the banks, such that the bank containing the right sample window is redesignated as the middle sample window, the bank containing the middle sample window is redesignated as the left sample window and the bank containing the left sample window is redesignated the right sample window. This renaming is performed for example by incrementing a counter associated with control inputs 513 that contains the numbers of the banks corresponding to the sample windows. In the present example, bank 510 becomes the middle sample window. After step S8, steps S1 to S8 are repeated.

In the present example, in the second deblock loop, the initiate step S1 now comprises checking whether the right sample window buffer is empty, which is now bank 511, and a second instruction Instr is received from FDU for the steps S2, S4 and S6. In step S3 the second sample window corresponding to macroblock 602 is loaded as a right sample window into bank 511. Horizontal deblocking is performed in step S5, based on the right sample window, and vertical deblocking is performed in step S7 based on both the right and middle sample windows. In step S8, the middle sample window in bank 510 becomes the left sample window, which is ready for output, and the right sample window in bank 511 becomes the middle sample window, while the left sample window in bank 512 becomes the new right sample window.

In the next deblock loop, a third sample window comprising macroblock 603 is fetched in S1 and loaded into bank 512 in S3. The banks 510, 511 and 512 now contain the left, middle and right sample windows respectively relating to macroblocks 601, 602 and 603.

If the deringing filter is to be applied, macroblock 601 is first output to the deringing threshold block 516 shown in FIG. 5, in which thresholds used by the deringing filter are computed and stored. Then an output sample window, which is the width of a macroblock wide and two samples more than a macroblock in height, in other words slightly smaller than the left sample window, is output to the deringing filter via multiplexer 520, along with the computed thresholds from block 516. The deringing filter may or may not be applied based on the computed thresholds.

On the other hand, if the deringing filter is not to be applied, the deringing threshold block is not activated to compute thresholds, and an output sample window, which is the width of a macroblock and variable in height, comprising macroblock 601, is output to the deringing filter via multiplexer 520. The output sample window passes through the deringing filter without being filtered.

The output sample windows are provided in packets of 4 adjacent samples of 8 bits, which can be output in row-first or column-first order by either selecting or not selecting the output of transpose block 515 by multiplexer 518.

The deblock loop is repeated until all of the luma macroblocks in an image that need to be deblocked have been, and these have been output to the deringing filter.

FIG. 6B illustrates a 3 by 3 block of chroma macroblocks 611 to 619, and illustrates the left, middle and right sample windows relating to macroblocks 614, 615 and 616 respectively. The sample windows each comprise 16 blocks of 4 by 4 blue and red chroma samples, labeled 0 to 15 in FIG. 6B. As illustrated by labeling “B” and “R”, in this example alternate columns relate to blue and red samples. The blue and red samples are deblocked separately by the deblocking unit 412. The deblocking process for chroma samples is performed in the same way as the process for luma samples, and will not be discussed in detail.

As shown in FIG. 8, deblocking of samples in an image frame is preferably performed in “Z” fashion, rows of macroblocks being processed in order from a top row to a bottom row, and macroblocks in each row being processed from left to right. FIG. 8 illustrates the three sample windows as a single rectangle 800. At the right-hand end of one row, after the final macroblock in the row has been deblocked and has become part of the middle sample window as shown by dashed rectangle 802, a sample window comprising the first macroblock of the next row can be loaded as the right sample window, and for this macroblock, horizontal deblocking is generally performed, while vertical deblocking is performed only if there are vertical edges inside the macroblock of the right sample window.

The deblocking step S5 of FIG. 7 will now be described with reference to the flow diagram shown in FIG. 9, and the circuit elements of the window buffer shown in FIG. 5.

The filtering of an edge comprises a number of steps, each step comprising filtering four consecutive pieces of edges. A piece of edge is the boundary between two adjacent pixel samples, and thus for example a horizontal edge that traversed a luma macroblock comprises 16 pieces of edge. Each filter step is performed on an 8 by 4 block of samples, in other words two adjacent sub-blocks, of which one sub-block is on one side of the four pieces of edges being processed, and the other sub-block is on the other side of the four pieces of edge being processed. This set of 4 consecutive pieces of edge will be referred to as a block edge or bedge. For example, the horizontal edge between sub-blocks 4 and 8 of macroblock 606 of FIG. 6A is a bedge, and sub-blocks 4 and 8 are the samples used to perform deblocking on this bedge. An edge of size N can generally be processed in N/4 bedge steps. For example, a horizontal luma edge comprising 16 pieces of edge can generally be processed in four steps.

In the starting step S50, the start of the deblocking operation is triggered by entering steps DEB1 S5 or DEB2 S7 of the deblocking loop.

In S51, a loop index “step” is set as the first step of the edge to be processed “first_step( )”, and a loop index “edge” is set as “0” corresponding to the first edge to be processed. For example, when performing the deblocking shown in FIG. 2A, the first edge is edge 1.

The next step is S52, in which parameter bedge_en is retrieved from the FDU 404. This parameter indicates whether or not the particular bedge is to be filtered, typically based on the bedge position within the frame, and global parameters retrieved by FDU 404 from the DMA via link 420.

The next step is S53, in which bedge is checked to determine whether the first bedge is to be filtered. If so, it is filtered in step S54 in an algorithm named “Filter_bedge”, which has as input parameters the direction of the filter (vertical or horizontal), the edge index representing which edge is to be filtered, and the step index representing which bedge is to be filtered inside the considered edge. For this, the sub-block on the left or upper side of the bedge to be processed is first loaded in to the P buffer 504 of FIG. 5.

In the case of luma values, an optional RCDO preprocessing is then performed to extract a decision criteria based on sum of absolute differences (SAD) from two consecutive bedges. RCDO is for example used by the H.264 RCDO standard. This step involves loading the sub-block on the other side of the bedge into the Q buffer 506, computing, by the deblocking unit 410, the sum of absolute differences between the contents of the P and Q buffers, loading the P and Q buffers with sub-blocks of a next step, computing the sum of absolute differences again, and merging the results. This result is used during the subsequent deblocking to make filtering decisions. The sub-block on the left or upper side of the bedge is then reloaded into the P buffer.

Whether or not RCDO is performed, the sub-block on the other side of the four pieces of edge to be processed is then loaded into the Q buffer 506 of FIG. 5. Each piece of edge is then processed in turn by deblocking unit 410, based on the filtering algorithm to be applied, which for example depends on the compression standard. When completed, the P and Q buffers have been updated, and are stored in the corresponding memory bank of memory 508 to update the corresponding samples. In some embodiments, memory 508 supports partial write access, and the results that would normally be stored by the deblocking unit in the P buffer can be stored directly in memory 508. In this case, only the contents of the Q buffer are written back to memory 508 after deblocking.

In S55, it is determined whether the last step for the processing of the edge has been completed, which means that the current edge has been completed. If not, the step is incremented in S56, and S53 and S54 are repeated. Generally four steps are performed, and once the last step has been completed, S57 is performed.

In S57, it is determined whether the last edge has been filtered. The number of edges depends on the compression standard. If more edges for DEB1 filtering need to be filtered, S58 is performed, in which “step” is reset to “first_step( )”, and “edge” is incremented, and then steps S52 to S56 are repeated. Otherwise, the S59 is the last step in which “step” is reset to “first_step( )” and “edge” is reset to “0”.

In alternative embodiments, steps S50 and S51 can be merged into a single step S50, and step S59 replaced by a link to step S50. This allows the state machine of the deblocking filter to be restarted without delay when performing DEB1 followed by DEB2.

S7 of FIG. 7 is the same as S5, except that if S5 relates to horizontal edges, then S7 relates to vertical edges, and vice versa.

FIG. 10 illustrates an electronic device 1000 comprising an interconnect 1001, coupled to a processor 1002, a memory 1004, a CODEC (compression decompression block) 1006 which comprises the deblocking circuitry described herein, a display 1008, an input port 1010 and an output port 1012. The CODEC 1006 is coupled through the interconnect to the display 1008 for displaying a video stream received either from input port 1010 or stored on memory 1004 and decoded and decompressed by CODEC 1008. Alternatively, video from a camera for example could be input at port 1010, or stored by memory 1004, and encoded using CODEC 1006, including use of the deblocking filter, and the resulting video stream output on port 1012. Device 1000 is for example a mobile telephone, portable games console, portable media player, PDA (personal digital assistant), camcorder or the like. Alternatively, device 1000 could be a set top box, or other type of media player, and may or may not comprise the in-built display 1008.

The embodiments described herein allow deblocking of a macroblock to be performed in two cycles, a first cycle in which the relevant sample window is loaded, and a second cycle in which the updated sample window is stored. This is achieved by providing the system of three memory banks, two of which are used for deblocking a macroblock, and one of which is used for outputting data.

Furthermore, very few load operations are required according to embodiments. This is made possible by loading windows of words, each window comprising a macroblock to be processed, as well as pixel samples from two adjacent macroblocks.

Having thus described at least one illustrative embodiment, various alterations, modifications and improvements will readily occur to those skilled in the art. For example, while deblocking of progressive pictures has been described for common standards, any type of interlaced picture or standard could be supported, by describing the deblocking algorithm in a way so that it is based on processing of one macroblock at a time, and adjusting the size of the sample windows so that the samples that are needed can be present in either the right sample window or the middle sample window.

Furthermore, it will be apparent to those skilled in the art that while in embodiments of the window buffers described herein two P and Q buffers are used for deblocking bedges, in alternative embodiments different buffer arrangements could be used.

While the deblocking filter and window buffers described above are implemented in hardware, parts could be implemented in software, which could for example allow the deblocking filter to be reprogrammable during its lifetime, such that it can support new video standards.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet, are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A multi-standard deblocking filter to deblock video images, the filter comprising:
a deblocking unit configured to deblock edges of a current macroblock of an image based on samples taken from a first sample window comprising the current macroblock and a second sample window adjacent to the first sample window;
three memory banks coupled to the deblocking unit, a first one of the memory banks arranged to store samples of the first sample window, a second one of the memory banks arranged to store samples of the second sample window, and a third one of the memory banks arranged store samples of a third sample window adjacent to the second sample window comprising a macroblock deblocked in a previous deblocking operation; and
control circuitry arranged to control, during a macroblock deblocking operation, loading and deblocking of the current macroblock and outputting of samples of the third sample window from the third one of the memory banks.

2. The multi-standard deblocking filter of claim 1, further comprising circuitry configured to redesignate the memory banks after each deblocking operation such that the first sample window becomes the second sample window and the second sample window becomes the third sample window.

3. The multi-standard deblocking filter of claim 1, further comprising first and second buffers arranged to store blocks of samples taken from the first and second sample windows for processing by the deblocking unit.

4. The multi-standard deblocking filter of claim 3, further comprising an interconnect coupled to the first and second buffers, to the three memory banks, to a memory controller and to the deblocking unit, the interconnect configured to simultaneously allow communication between the first buffer and the deblocking unit and between the second buffer and one of the three memory banks.

5. An electronic device comprising:
a processor;
a memory;
a deblocking unit configured to deblock edges of a current macroblock of an image based on samples taken from a first sample window comprising the current macroblock and a second sample window adjacent to the first sample window;
three memory banks coupled to the deblocking unit, a first one of the memory banks arranged to store samples of the first sample window, a second one of the memory banks arranged to store samples of the second sample window, and a third one of the memory banks arranged store samples of a third sample window adjacent to the second sample window comprising a macroblock deblocked in a previous deblocking operation; and
control circuitry arranged to control, during a macroblock deblocking operation, loading and deblocking of the current macroblock and outputting of samples of the third sample window from the third one of the memory banks.

6. The electronic device of claim 5, further comprising a display.

7. The electronic device of claim 6, further comprising a transceiver configured to send and receive mobile telephone communication signals.

8. A method of deblocking multi-standard video images, comprising:
loading samples of a first sample window of a video image into a first memory bank, the first sample window comprising a current macroblock to be deblocked;
deblocking edges of the current macroblock based on samples taken from the first sample window and samples taken from a second sample window adjacent to the first sample window and stored in a second memory bank and storing a result in the first and/or second memory banks; and
during the loading and deblocking steps, outputting samples of a third sample window stored in a third memory bank.

9. The method of claim 8, further comprising renaming the first and second memory banks after the deblocking step such that the first sample window becomes the second sample window and the second sample window becomes the third sample window, and loading a next macroblock to be deblocked into the third memory bank.

10. The method of claim 8 wherein the outputting step comprises outputting the samples of the third sample window to a deringing filter.

11. The method of claim 8 wherein the loading, deblocking and outputting steps relate to luma samples of a video image, and further comprising performing the loading, deblocking and outputting steps for chroma samples of the video image.

12. The method of claim 8 wherein the first sample window further comprises a plurality of samples of at least one macroblock adjacent to the current macroblock.

13. A video image deblocking filter, comprising:
a window buffer configured to:
store a sample window including samples of a current macroblock and a sample window including samples of a macroblock adjacent to the current macroblock; and
output samples from a sample window including samples of a previously deblocked macroblock; and
a deblocking module coupled to the window buffer and configured to deblock edges of the current macroblock based on stored samples from the window including samples of the current macroblock and stored samples from the window including samples of the macroblock adjacent to the current macroblock.

14. The video image deblocking filter of claim 13 wherein the window buffer comprises three memory banks and a controller configured to control storage of the sample windows in the three memory banks and to control access by the deblocking module to the memory banks.

15. The video image deblocking filter of claim 13 wherein the window buffer controller is configured to redesignate the memory banks in response to completion of deblocking of the current macroblock.

16. A computer readable memory medium storing instructions to cause a video signal processing system to perform a method, the method comprising:
loading samples of a first sample window of a video image into a first memory bank, the first sample window comprising a current macroblock to be deblocked;
deblocking edges of the current macroblock based on samples taken from the first sample window and samples taken from a second sample window adjacent to the first sample window and stored in a second memory bank and storing a result in the first and/or second memory banks; and
during the loading and deblocking steps, outputting samples of a third sample window stored in a third memory bank.

17. The computer readable memory medium of claim 16 wherein the method further comprises redesignating the first and second memory banks after the deblocking step such that the first sample window becomes the second sample window and the second sample window becomes the third sample window, and loading a next macroblock to be deblocked into the third memory bank.

18. The computer readable memory medium of claim 16 wherein the outputting step comprises outputting the samples of the third sample window to a deringing filter.

19. The computer readable memory medium of claim 16 wherein the loading, deblocking and outputting steps relate to luma samples of a video image, and the method further comprises performing the loading, deblocking and outputting steps for chroma samples of the video image.

20. A system, comprising:
means for storing at least three windows of samples associated with a video image;
means for deblocking edges of macroblocks in the video image based on samples of a macroblock to be deblocked and samples of a macroblock adjacent to the macroblock to be deblocked;
means for designating for a deblocking cycle windows of samples in the means for storing as associated with the macroblock to be deblocked, the macroblock adjacent to the macroblock to be deblocked, and a previously deblocked macroblock, wherein the means for deblocking is configured to retrieve the samples of the macroblock to be deblocked from the window of samples associated with the macroblock to be deblocked and to retrieve the samples of the macroblock adjacent to the macroblock to be deblocked from the window of samples associated with the macroblock adjacent to the macroblock to be deblocked; and
means for outputting samples from the window associated with the previously deblocked macroblock during the deblocking cycle.

21. The system of claim 20 wherein the means for storing comprises three memory banks each configured to store a window of samples associated with the video image and the means for designating is configured to selectively designate the memory banks with respective macroblocks associated with the video image.

22. The system of claim 20, wherein the means for designating is configured to redesignate the windows of samples in the means for storing in response to a completion of a deblocking cycle.
